(19) United States
(12) Patent Application Publication
(10) Pub. No.: US 2024/0349833 A1
(43) Pub. Date: Oct. 24, 2024

(54) FLAME RESISTANT NONWOVEN FABRICS AND COMPOSITES AND GARMENTS MADE WITH SAME

(71) Applicant: Southern Mills, Inc., Union City, GA (US)

(72) Inventors: Robert Self, Peachtree City, GA (US); Willie Clearance Smith, Atlanta, GA (US)

(21) Appl. No.: 18/639,495

(22) Filed: Apr. 18, 2024

Related U.S. Application Data
(60) Provisional application No. 63/460,177, filed on Apr. 18, 2023.

(51) Int. Cl. A41D 31/08; A41D 27/02; A62B 17/00; B32B 5/02; B32B 5/26; D04H 1/4334; D04H 1/4342; D04H 1/4374; D04H 1/4382

(52) U.S. Cl. CPC A41D 31/085; A41D 27/02; A62B 17/003; B32B 5/022; B32B 5/266; B32B 5/267; D04H 1/4334; D04H 1/4342; D04H 1/4374; D04H 1/43835; A41D 2500/30; B32B 2250/20; B32B 2262/0261; B32B 2262/0269; B32B 2262/144; B32B 2307/3065; B32B 2307/7246; B32B 2437/00; B32B 2571/00; D10B 2401/04; D10B 2501/06

(57) ABSTRACT

Embodiments of the present invention replace at least some of the flame resistant fibers traditionally used in the batting of a thermal liner (e.g., aramids) with thermally stable polyamide fibers (e.g., nylon fibers). The TPP performance of garments incorporating embodiments of thermal liners contemplated herein is comparable to—if not improved over—garments formed with traditional thermal liners.

### CROSS REFERENCE TO RELATED APPLICATIONS

This application claims the benefit of U.S. Provisional Application Ser. No. 63/460,177, filed on Apr. 18, 2023, entitled “Improved Flame Resistant Thermal Liners and Garments Made with Same,” the entirety of which is hereby incorporated by this reference.

### FIELD

Embodiments of the present invention relate to improved nonwoven fabrics and protective composites and garments incorporating such nonwoven fabrics.

### BACKGROUND

Protective garments are designed to protect the wearer from hazardous environmental conditions the wearer might encounter. Such garments include those designed to be worn by firefighters and other rescue personnel, industrial and electrical workers, and military personnel. Firefighters, emergency responders, search and rescue personnel, and those engaged in military service can be exposed to extreme heat and/or flames while working. Protective garments are designed and constructed as a way of combatting injury. These protective garments, commonly referred to as turnout gear (including coveralls, trousers, and jackets), can be constructed of special flame resistant materials designed to protect workers from both heat and flames.

Standards have been promulgated that govern the performance of such garments (or constituent layers or parts of such garments) to ensure that the garments sufficiently protect the wearer in hazardous situations. National Fire Protection Association (NFPA) 1971 (Standard on Protective Ensembles for Structural Fire Fighting and Proximity Fire Fighting, 2018 edition, incorporated herein by reference) governs the required performance of firefighter garments.

Structural firefighter garments, such as firefighters' turnout gear, typically consist of matching coat and pants and are designed primarily to prevent the wearer from sustaining a serious burn. NFPA 1971 compliant turnout gear or garments 10 are typically comprised of three layers (as shown in FIGS. 1 and 2): an outer shell 12, an intermediate moisture barrier 14, and a thermal liner 20. The outer shell 12 is usually a woven fabric made from flame resistant fibers and is considered a firefighter's first line of defense. Not only should it resist flame, but it needs to be tough and durable so as not to be torn, abraded, or snagged during normal firefighting activities.

The moisture barrier 14, which is also flame resistant, is present to keep water, harmful chemicals, bacteria, and bodily fluids from penetrating the turnout gear and affecting the wearer. The moisture barrier 14 can be constructed of a non-woven or woven flame resistant fabric 16 that is laminated to a water-impermeable layer of material 18 such as, for instance, a layer of expanded polytetrafluoroethylene (“ePTFE”), polyurethane, or combinations thereof.

The thermal liner 20 is flame resistant and offers the bulk of the thermal protection afforded by the ensemble. A traditional thermal liner consists of a batting of flame resistant thermal insulating materials 22 quilted to a lightweight facecloth 24, also made of flame resistant fibers. The facecloth 24 is commonly quilted to the batting 22 in a cross-over or chicken wire pattern. The thermal liner 20 is the innermost layer of the firefighter's garment, with the facecloth 24 typically facing the wearer.

The batting 22 of the thermal liner can be a single layer of nonwoven fabric, but more typically is formed of multiple nonwoven layers. For example, the nonwoven fabrics used in many thermal liners are 1.5 ounces per square yards (“osy”) and/or 2.3 osy spunlace fabrics. These spunlace fabrics are typically formed with a high percentage (often 100%) of expensive inherently flame resistant fibers, such as para-aramid and/or meta-aramid fibers.

NFPA 1971 requires that garments and/or individual layers or parts thereof pass a number of different performance tests, including having a char length of 4 inches or less and of having a two second (or less) after flame, when measured pursuant to the testing methodology set forth in ASTM D6413 (Standard Test Method for Flame Resistance of Textiles, 2015 edition, incorporated herein by reference). To test for char length and after flame, a fabric specimen is suspended vertically over a flame for twelve seconds. The fabric must self-extinguish within two seconds (i.e., it must have a 2 second or less after flame). After the fabric self-extinguishes, a specified amount of weight is attached to the fabric and the fabric lifted so that the weight is suspended from the fabric. The fabric will typically tear along the charred portion of the fabric. The length of the tear (i.e., the char length) must be 4 inches or less when the test is performed in both the machine/warp and cross-machine/weft directions of the fabric. A fabric sample is typically tested for compliance both before it has been washed (and thus when the fabric still contains residual—and often flammable—chemicals from finishing processes) and after a certain number of launderings (5 launderings for NFPA 1971).

NFPA 1971 also contains requirements relating to the extent to which the fabric shrinks when subjected to heat when tested pursuant to ASTM F2894-21 (Standard Test Method for Evaluation of Materials, Protective Clothing, and Equipment for Heat Resistance Using a Hot Air Circulating Oven, 2021 edition, incorporated herein by reference). To conduct thermal shrinkage testing on fabrics, marks are made on the fabric a distance from each other in both the machine/warp and cross-machine/weft directions. The distance between sets of marks is noted. The fabric is then suspended in a 500 degree fahrenheit oven for 5 minutes. The distance between sets of marks is then re-measured. The thermal shrinkage of the fabric is then calculated as the percentage that the fabric shrinks in both the machine/warp and cross-machine/weft directions and must be less than the percentage set forth in the applicable standard. For example, NFPA 1971 requires that outer shell fabrics exhibit thermal shrinkage of no more than 10% in both the machine/warp and cross-machine/weft directions.

The thermal protection that a garment fabric affords the wearer is measured by determining the fabric's Thermal Protective Performance (TPP) in accordance with ISO 17492: Clothing for protection against heat and flame—Determination of heat transmission on exposure to both flame and radiant heat (2019, incorporated herein by this reference), as modified by NFPA 1971. The TPP test predicts the rate at which radiant and convective heat transfer through the three layers of the garment fabric (outer shell, moisture barrier, and thermal liner) to a level that will cause a second-degree burn to the human skin. More specifically, the test measures the amount of time at a given energy level it takes for enough heat to pass through the composite to cause a second degree burn. The minimum TPP rating for NFPA 1971-compliant coats and trousers is 35 calories/cm² (which equates to about 17.5 seconds of protection before a second-degree burn results). The higher the number, the more protective the garment system is considered. The TPP test method is fully described in chapter 8.10 of NFPA 1971.

### SUMMARY

The terms “invention,” “the invention,” “this invention” and “the present invention” used in this patent are intended to refer broadly to all of the subject matter of this patent and the patent claims below. Statements containing these terms should not be understood to limit the subject matter described herein or to limit the meaning or scope of the patent claims below. Embodiments of the invention covered by this patent are defined by the claims below, not this summary. This summary is a high-level overview of various aspects of the invention and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to the entire specification of this patent, all drawings and each claim.

Embodiments of the present invention replace at least some of the flame resistant fibers traditionally used in the batting of a thermal liner (e.g., aramids) with thermally stable polyamide fibers (e.g., nylon fibers). The TPP performance of garments incorporating embodiments of thermal liners contemplated herein is comparable to—if not improved over—garments formed with traditional thermal liners.

### BRIEF DESCRIPTION OF THE FIGURES

Illustrative embodiments of the present invention are described in detail below with reference to the following drawing figures:

FIG. 1 illustrates a partial cut-away view of a prior art protective garment.

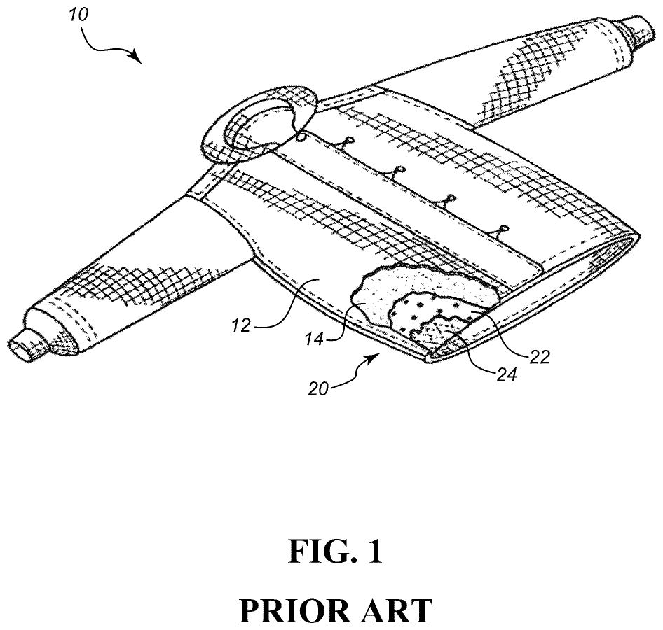

FIG. 2 illustrates an exploded perspective view of a portion of the prior art protective garment illustrated in FIG. 1.

### DETAILED DESCRIPTION

The subject matter of embodiments of the present invention is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

Embodiments of the present invention replace at least some of the more expensive inherently flame resistant fibers used in the nonwoven layers of traditional battings 22 (e.g., aramid fibers) with thermally stable polyamide (e.g., nylon) fibers. Because traditional polyamide materials such as nylon are thermoplastic and offer no inherent flame resistance or thermal stability, they are prone to melt and burn when subjected to heat and flame. Traditional nylon fibers are referred to herein as “non-thermally stable nylon fibers” or “NTS nylon fibers.” Consequently, such materials historically have only been included in flame resistant fabrics in minimal amounts to avoid sacrificing the protective properties of such fabrics. However, polyamide fibers that offer more thermal stability (in particular, but not exclusively, are less apt to melt and/or drip) have been developed, thereby minimizing the detrimental impact nylon fibers traditionally have had on the thermal performance of fabrics in which they are included. For purposes of this disclosure, “thermally stable nylon fibers” or “TS nylon fibers” is used to refer to the class of nylon fibers that exhibit one or more improved thermal properties as compared to traditional NTS nylon fibers, such as (but not limited to) better resistance to burning, more self-extinguishing, and/or reduced melt/drip properties. Thus, larger amounts of these thermally stable (“TS”) nylon fibers may be blended with other flame resistant fibers to create flame resistant fabrics that attain the requisite performance properties (including, but not limited to, compliance with the requirements of NFPA 1971). Examples of such TS nylon fibers include, but are not limited to, those taught in U.S. Pat. No. 10,640,893 (incorporated herein by reference).

Embodiments of the nonwoven fabric include TS nylon fibers in combination with one or more other flame resistant fibers. The other flame resistant fibers may be inherently flame resistant fibers (e.g., aramid fibers, modacrylic fibers, etc.) or may be fibers that have been treated with a flame retardant to render them flame resistant (e.g., FR cotton, FR rayon, FR acetate, FR triacetate, and FR lyocell). Non-FR fibers may be present in some embodiments of the nonwoven fabrics contemplated herein.

In some embodiments, the nonwoven fabric is formed of: (i) 1-70% by weight (wt. %), inclusive; 5-70 wt. %, inclusive; 10-70 wt. %, inclusive; 15-70 wt. %, inclusive; 20-70 wt. %, inclusive; 30-70 wt. %, inclusive; 40-70 wt. %, inclusive; 50-70 wt. %, inclusive; 60-70 wt. % inclusive; 20-65 wt. %, inclusive; 25-60 wt. %, inclusive; 30-50 wt. %, inclusive; and/or 40-60 wt. %, inclusive, TS nylon fibers and (ii) 30-99 wt. %, inclusive; 30-95 wt. %, inclusive; 30-90 wt. %, inclusive; 30-85 wt. %, inclusive; 30-80 wt. %, inclusive; 30-70 wt. %, inclusive; 30-60 wt. %, inclusive; 30-50 wt. %, inclusive; 30-40 wt. %, inclusive; 35-80 wt. %, inclusive; 40-75 wt. %, inclusive; 50-80 wt. %, inclusive; and/or 40-60% wt. %, inclusive, other flame resistant fibers (aramid fibers, modacrylic fibers, FR cellulosic fibers, and/or blends thereof). Embodiments of the nonwoven fabric may be formed of a blend of TS nylon fibers and:
meta-aramid fibers;
para-aramid fibers;
meta-aramid and para-aramid fibers;
aramid fibers (meta- and/or para-aramid fibers) and modacrylic fibers;
para-aramid fibers and modacrylic fibers;
aramid fibers (meta- and/or para-aramid fibers) and FR cellulosic fibers;
para-aramid fibers and FR cellulosic fibers;
aramid fibers (meta- and/or para-aramid fibers) and FR rayon fibers;
para-aramid fibers and FR rayon fibers;
aramid fibers (meta- and/or para-aramid fibers), modacrylic fibers, and FR cellulosic fibers; and/or
para-aramid fibers, modacrylic fibers, and FR rayon fibers.

Embodiments of the nonwoven fabrics may be formed with any of the fiber blends (or combinations thereof) set forth above provided in any of the weight percentages (or combinations thereof) set forth above. In some embodiments, the nonwoven fabric is devoid of meta-aramid fibers. In some embodiments, the nonwoven fabric includes at least 20 wt. %, at least 25 wt. %, at least 30 wt. %, at least 35 wt. %, at least 40 wt. %, at least 45 wt. %, at least 50 wt. %, at least 55 wt. %, at least 60 wt. %, or at least 65 wt. % TS nylon fibers. In some embodiments, the nonwoven fabric includes at least 5 wt. %, at least 10 wt. %, at least 15 wt. %, at least 20 wt. %, at least 25 wt. %, or at least 30 wt. % para-aramid fibers.

In some embodiments, the nonwoven fabric is a spunlace fabric, but it could be other types of nonwoven fabrics, including, but not limited to, a needlepunched, airlaid, or wetlaid nonwoven fabric.

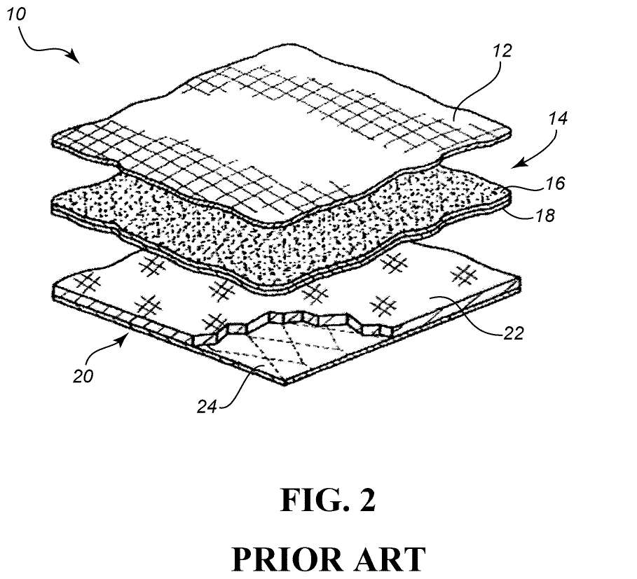

While the nonwoven fabric could be used in any suitable application, in some embodiments the nonwoven fabric is substituted for one or more (or all) of the nonwoven layers of the batting 22 of the thermal liner 20 (see FIG. 2). The batting layers provided in the thermal liner 20 can be, but need not be, the same. Rather, different batting layers may be combined in different ways within the thermal liner 20. In some embodiments, the batting 22 is formed of multiple nonwoven layers, one or more of which is an inventive nonwoven fabric disclosed herein and one or more of which is a traditional batting layer.

In some embodiments, the nonwoven fabric weighs 0.3 to 10 osy, inclusive; 0.3-9 osy, inclusive; 0.3-8 osy, inclusive; 0.3-7 osy, inclusive; 0.3-6 osy, inclusive; 0.3-5 osy, inclusive; 0.3-4 osy, inclusive; 0.3-3 osy, inclusive; 0.3-2 osy, inclusive; 0.3-1 osy, inclusive; 1-8 osy, inclusive; 2-7 osy, inclusive; 3-5 osy, inclusive; and/or 4-6 osy, inclusive.

Provided below in Table 1 are examples of prior art thermal liners (“Control Thermal Liner”) and non-limiting examples of thermal liners in accordance with embodiments of the invention (“Inventive Thermal Liners”). The various layers of the thermal liners were assembled and quilted together.

TABLE 1

| | | Weight |
|---|---|---|
| Thermal Liner | Structure (top to bottom) | (osy) |
| Control Thermal Liner 1 | 2.3 osy spunlace (67/33 meta- | 7.6 |
| (Prior Art, sold under the | aramid/para-aramid) | |
| name Titanium ™ SL2) | 1.5 osy spunlace (67/33 meta- | |
| | aramid/para-aramid) | |
| | Titanium ™ Facecloth | |
| Control Thermal Liner 2 | 2.3 osy spunlace (67/33 meta- | 8.1 |
| (Prior Art, sold under the | aramid/para-aramid) | |
| name Defender ® M SL2) | 2.3 osy spunlace (67/33 meta- | |
| | aramid/para-aramid) | |
| | Defender ® M Facecloth | |
| Inventive Thermal Liner 1 | 2.3 osy spunlace (67/33 TS nylon/ | 7.7 |
| | para-aramid) | |
| | 1.5 osy spunlace (67/33 TS nylon/ | |
| | para-aramid) | |
| | Titanium ™ Facecloth | |
| Inventive Thermal Liner 2 | 2.3 osy spunlace (67/33 TS nylon/ | 8.1 |
| | para-aramid) | |
| | 2.3 osy spunlace (67/33 TS nylon/ | |
| | para-aramid) | |
| | Defender ® M Facecloth | |

The term “Titanium™ Facecloth” refers to a flame resistant woven fabric formed of 100% meta-aramid filament yarns in the fill direction woven with spun yarns in the warp direction formed of a blend of 65% rayon fibers/25% para-aramid fibers/10% NTS nylon fibers. The fabric weighs approximately 3.5 osy and is available from TenCate®.

The term “Defender® M Facecloth” refers to a flame resistant woven fabric formed of spun yarns provided in the warp and fill directions that are formed of a blend of 65% rayon fibers/25% para-aramid fibers/10% NTS nylon fibers. The fabric weighs approximately 3.2 osy and is available from TenCate®.

The Control Thermal Liners and the Inventive Thermal Liners described in Table 1 were incorporated into a conventional material layup for firefighter's garments that complies with NFPA 1971 so as to form a garment composite (i.e., a fabric composite with an outer shell, moisture barrier, and thermal liner) for turnout gear. More specifically, the Control Thermal Liners and the Inventive Thermal Liners were incorporated into the garment composites set forth in Table 2.

TABLE 2

| | Outer Shell | Moisture Barrier | Thermal Liner |
|---|---|---|---|
| Control | Pioneer ™ | CROSSTECH | Control Thermal |
| Garment | | BLACK ® | Liner 1 |
| Composite 1 | | | |
| Control | Pioneer ™ | CROSSTECH | Control Thermal |
| Garment | | BLACK ® | Liner 2 |
| Composite 2 | | | |
| Control | Kombat ™ | CROSSTECH | Control Thermal |
| Garment | Flex | BLACK ® | Liner 1 |
| Composite 3 | | | |
| Control | Kombat ™ | CROSSTECH | Control Thermal |
| Garment | Flex | BLACK ® | Liner 1 |
| Composite 4 | | | |
| Inventive | Pioneer ™ | CROSSTECH | Inventive Thermal |
| Garment | | BLACK ® | Liner 1 |
| Composite 1 | | | |
| Inventive | Pioneer ™ | CROSSTECH | Inventive Thermal |
| Garment | | BLACK ® | Liner 2 |
| Composite 2 | | | |
| Inventive | Kombat ™ | CROSSTECH | Inventive Thermal |
| Garment | Flex | BLACK ® | Liner 1 |
| Composite 3 | | | |
| Inventive | Kombat ™ | CROSSTECH | Inventive Thermal |
| Garment | Flex | BLACK ® | Liner 1 |
| Composite 4 | | | |

Definitions of the terminology used in Table 2 are as follows:
“CROSSTECH BLACK®” refers to a capped ePTFE layer laminated to a woven meta-aramid fabric layer. This moisture barrier is flame resistant, air impermeable, vapor permeable, and waterproof. CROSSTECH BLACK® is available from Gore®.
“Pioneer™” refers to a 100% aramid (i.e., flame resistant) outer shell fabric available from TenCate®.
“Kombat™ Flex” refers to a woven flame resistant fabric available from TenCate®.

The Control and Inventive Thermal Liners were positioned in the Garment Composites such that the top layer of the Thermal Liners (see Table 1) was positioned adjacent the moisture barrier. The Control and Inventive Garment Composites were tested for TPP performance before wash and the results are set forth in Table 3.

TABLE 3

| | Composite | Composite | Composite |
|---|---|---|---|
| | TPP | Weight | TPP/Weight |
| | (calories/cm²) | (osy) | Ratio |
| Control Garment | 39.3 | 18.1 | 2.2 |
| Composite 1 | | | |
| Control Garment | 42.1 | 18.6 | 2.3 |
| Composite 2 | | | |
| Control Garment | 36.8 | 19.1 | 1.9 |
| Composite 3 | | | |
| Control Garment | 36.1 | 19.1 | 1.9 |
| Composite 4 | | | |
| Inventive Garment | 44.9 | 18.3 | 2.5 |
| Composite 1 | | | |
| Inventive Garment | 45.7 | 18.8 | 2.4 |
| Composite 2 | | | |
| Inventive Garment | 41.2 | 19.9 | 2.1 |
| Composite 3 | | | |
| Inventive Garment | 38.8 | 19.7 | 2.0 |
| Composite 4 | | | |

As demonstrated by the data in Table 3, garment composites in accordance with embodiments of the invention have a TPP rating of at least 35 cal./cm² (in compliance with NFPA 1971) and higher, at least 38 cal./cm² and higher, at least 40 cal./cm² and higher, at least 42 cal./cm² and higher, at least 44 cal./cm² and higher, and at least 45 cal./cm² and higher.

The conventional wisdom in the industry has been that nylon fibers detrimentally impact TPP performance. Embodiments of the present invention prove that wisdom wrong. Rather, replacement of more protective (and expensive) fibers (the meta-aramid fibers present in the Control Thermal Liners) with less protective (and less expensive) TS nylon fibers (as in the Inventive Thermal Liners) does not detrimentally impact the TPP performance of the garments into which they are incorporated (the Inventive Garment Composites). As evident from Table 3, garment composites that include the Inventive Thermal Liners (those with TS nylon fibers) had TPP ratings that exceeded the TPP ratings of garment composites formed with conventional thermal liners (such as the Control Thermal Liners that included meta-aramid fibers), but that were otherwise identical.

By way of example, the garment composites within Tables 4A-4C are compositionally identical (i.e., formed of the same materials/layers in the same amounts) to the other garment composite(s) within the same table except that the meta-aramid fibers in the batting of the thermal liner of the Control Garment Composite(s) are replaced with TS nylon fibers in the Inventive Garment Composite(s).

TABLE 4A

| | Composite | Composite | Composite |
|---|---|---|---|
| | TPP | Weight | TPP/Weight |
| | (calories/cm²) | (osy) | Ratio |
| Control Garment | 39.3 | 18.1 | 2.2 |
| Composite 1 | | | |
| Inventive Garment | 44.9 | 18.3 | 2.5 |
| Composite 1 | | | |

TABLE 4B

| | Composite | Composite | Composite |
|---|---|---|---|
| | TPP | Weight | TPP/Weight |
| | (calories/cm²) | (osy) | Ratio |
| Control Garment | 42.1 | 18.6 | 2.3 |
| Composite 2 | | | |
| Inventive Garment | 45.7 | 18.8 | 2.4 |
| Composite 2 | | | |

TABLE 4C

| | Composite | Composite | Composite |
|---|---|---|---|
| | TPP | Weight | TPP/Weight |
| | (calories/cm²) | (osy) | Ratio |
| Control Garment | 36.8 | 19.1 | 1.9 |
| Composite 3 | | | |
| Control Garment | 36.1 | 19.1 | 1.9 |
| Composite 4 | | | |
| Inventive Garment | 41.2 | 19.9 | 2.1 |
| Composite 3 | | | |
| Inventive Garment | 38.8 | 19.7 | 2.0 |
| Composite 4 | | | |

In every instance, the TPP rating of the Inventive Garment Composite(s) in a table is greater than the TPP rating of the Control Garment Composite(s) within the same table, including (i) at least 3-15% greater, at least 5%-15% greater, 5%-10% greater, 7%-15% greater, 7%-10% greater, 8%-15% greater, 8%-10% greater, and/or 10%-15% greater or (ii) at least 3% greater, at least 4% greater, at least 5% greater, at least 6% greater, at least 7% greater, at least 8% greater, at least 9% greater, at least 10% greater, at least 11% greater, at least 12% greater, at least 13% greater, at least 14% greater and/or at least 15% greater.

The extent to which a composite's weight can be reduced while still achieving the requisite TPP protection is represented by the TPP rating to composite weight ratio, which normalizes any weight discrepancies between the composites. The TPP rating to composite weight ratio is essentially an indicator of how efficient the composite is at protecting the wearer. The higher the ratio, the more protection the wearer is afforded for a particular composite weight. Thus, higher TPP rating to composite weight ratios are desired as they represent composites that achieve the required TPP protection but at lighter weights so as to reduce the stress on the wearer. Garment composites in accordance with some embodiments have a TPP to composite weight ratio of at least 2.0 to 3.0, including at least 2.0; at least 2.1; at least 2.2; at least 2.3; at least 2.4; at least 2.5; at least 2.6; at least 2.7; at least 2.8; at least 2.9; and at least 3.0.

Again, in every instance the TPP rating to weight ratio of the Inventive Garment Composite(s) in a table is greater than the TPP rating to weight ratio of the Control Garment Composite(s) within the same table, including (i) at least 3%-15% greater, 3%-10% greater, 3%-8% greater, 5%-15% greater, 5%-10% greater, 5%-8% greater, and/or 10-15% greater or (ii) at least 3% greater, at least 4% greater, at least 5% greater, at least 6% greater, at least 7% greater, at least 8% greater, at least 9% greater, at least 10% greater, at least 11% greater, at least 12% greater, at least 13% greater, at least 14% greater and/or at least 15% greater. This improvement is achieved with cheaper, less protective fibers, which is directly contrary to conventional wisdom.

Garment composites in accordance with embodiments of the invention comply with the requirements of NFPA 1971, as well as the equivalent European standard, EN 469 (2005): Protective Clothing for Firemen (and subsequent editions), and the equivalent international standard, ISO 11999 (2015): PPE for firefighters—Test methods and requirements for PPE used by firefighters who are at risk of exposure to high levels of heat and/or flame while fighting fires occurring in structures (and subsequent editions), all of which are herein incorporated by reference. More specifically, they comply with the Heat Transfer Index (the European equivalent to TPP) requirements, when tested pursuant to EN 367 (1992): Protective clothing; protection against heat and fire; method for determining heat transmission on exposure to flame and its essential equivalent EN ISO 9151 (2016): Protective clothing against heat and flame; determination of heat transmission on exposure to flame. All standards and any subsequent editions thereof referenced herein are herein incorporated by reference.

Thus, a less expensive thermal liner may be incorporated into turnout garments without sacrificing—and indeed improving—the TPP performance of the garment composite. In any event, garment composites that incorporate embodiments of the thermal liners contemplated herein will pass the TPP requirement (as well as all other applicable requirements) of NFPA 1971.

### EXAMPLES

A collection of exemplary embodiments, including at least some explicitly enumerated as “Examples” providing additional description of a variety of example types in accordance with the concepts described herein are provided below. These examples are not meant to be mutually exclusive, exhaustive, or restrictive; and the invention is not limited to these example examples but rather encompasses all possible modifications and variations within the scope of the issued claims and their equivalents.

Example 1. A flame resistant thermal liner comprising a flame resistant facecloth and at least one nonwoven layer attached to the facecloth, wherein the at least one nonwoven layer comprises thermally stable nylon fibers.

Example 2. The flame resistant thermal liner of any of the preceding or subsequent examples or combination of examples, wherein the at least one nonwoven layer comprises two nonwoven layers, each comprising thermally stable nylon fibers.

Example 3. The flame resistant thermal liner of any of the preceding or subsequent examples or combination of examples, wherein the at least one nonwoven layer comprises a first nonwoven layer and a second nonwoven layer, wherein the first nonwoven layer comprises the thermally stable nylon fibers and the second nonwoven layer is devoid of thermally stable nylon fibers.

Example 4. The flame resistant thermal liner of any of the preceding or subsequent examples or combination of examples, wherein the at least one nonwoven layer comprises at least 20 wt. % thermally stable nylon fibers.

Example 5. The flame resistant thermal liner of any of the preceding or subsequent examples or combination of examples, wherein the at least one nonwoven layer further comprises flame resistant fibers.

Example 6. The flame resistant thermal liner of any of the preceding or subsequent examples or combination of examples, wherein the at least one nonwoven layer comprises 30-80 wt. % flame resistant fibers.

Example 7. The flame resistant thermal liner of any of the preceding or subsequent examples or combination of examples, wherein the flame resistant fibers comprise at least one of aramid fibers, modacrylic fibers, or flame resistant cellulosic fibers.

Example 8. The flame resistant thermal liner of any of the preceding or subsequent examples or combination of examples, wherein the flame resistant fibers comprise para-aramid fibers and the at least one nonwoven layer comprises at least 20 wt. % para-aramid fibers.

Example 9. The flame resistant thermal liner of any of the preceding or subsequent examples or combination of examples, wherein the at least one nonwoven layer is devoid of meta-aramid fibers.

Example 10. The flame resistant thermal liner of any of the preceding or subsequent examples or combination of examples, wherein the at least one nonwoven layer comprises a spunlace fabric.

Example 11. The flame resistant thermal liner of any of the preceding or subsequent examples or combination of examples, wherein the at least one nonwoven layer comprises 40-70 wt. % thermally stable nylon fibers and 30-60 wt. % flame resistant fibers.

Example 12. The flame resistant thermal liner of any of the preceding or subsequent examples or combination of examples, wherein the flame resistant fibers comprise para-aramid fibers.

Example 13. The flame resistant thermal liner of any of the preceding or subsequent examples or combination of examples, wherein the at least one nonwoven layer comprises 50-70 wt. % thermally stable nylon fibers and 30-50 wt. % flame resistant fibers.

Example 14. A garment composite comprising an outer shell layer comprising a flame resistant fabric; a moisture barrier layer; and a thermal liner layer comprising a flame resistant facecloth and at least one nonwoven layer attached to the facecloth, wherein the at least one nonwoven layer comprise thermally stable nylon fibers, wherein the flame resistant facecloth is exposed on a first side of the garment composite and the outer shell layer is exposed on a second side of the garment composite opposite the first side.

Example 15. The garment composite of any of the preceding or subsequent examples or combination of examples, wherein the garment composite has a thermal protective performance rating of at least 35 calories/cm² when tested pursuant to ISO 17492.

Example 16. The garment composite of any of the preceding or subsequent examples or combination of examples, wherein the garment composite has a thermal protective performance rating of at least 40 calories/cm² when tested pursuant to ISO 17492.

Example 17. The garment composite of any of the preceding or subsequent examples or combination of examples, wherein the garment composite has a composite weight and a thermal protective performance rating when tested pursuant to ISO 17492, wherein a ratio of the thermal protective performance rating to composite weight is between 2.0 and 3.0, inclusive.

Example 18. The garment composite of any of the preceding or subsequent examples or combination of examples, wherein the at least one nonwoven layer further comprises flame resistant fibers and wherein the garment composite has a composite weight and a thermal protective performance rating when tested pursuant to ISO 17492, wherein a thermal protective performance rating to composite weight ratio of the garment composite is greater than a thermal protective performance rating to composite weight ratio of a comparative garment composite having at least one nonwoven layer formed of 100% flame resistant fibers but otherwise compositionally identical to the garment composite.

Example 19. The garment composite of any of the preceding or subsequent examples or combination of examples, wherein the thermal protective performance rating to composite weight ratio of the garment composite is at least 5% greater than the thermal protective performance rating to composite weight ratio of the comparative garment composite.

Example 20. A nonwoven fabric formed of a fiber blend comprising flame resistant fibers and thermally stable nylon fibers.

Different arrangements of the components described above, as well as components and steps not shown or described are possible. Similarly, some features and sub combinations are useful and may be employed without reference to other features and subcombinations. Embodiments of the invention have been described for illustrative and not restrictive purposes, and alternative embodiments will become apparent to readers of this patent. Accordingly, the present invention is not limited to the embodiments described above or depicted in the drawings, and various embodiments and modifications can be made without departing from the scope of the invention.

We claim:

1. A flame resistant thermal liner comprising a flame resistant facecloth and at least one nonwoven layer attached to the facecloth, wherein the at least one nonwoven layer comprises thermally stable nylon fibers.

2. The flame resistant thermal liner of claim 1, wherein the at least one nonwoven layer comprises two nonwoven layers, each comprising thermally stable nylon fibers.

3. The flame resistant thermal liner of claim 1, wherein the at least one nonwoven layer comprises a first nonwoven layer and a second nonwoven layer, wherein the first nonwoven layer comprises the thermally stable nylon fibers and the second nonwoven layer is devoid of thermally stable nylon fibers.

4. The flame resistant thermal liner of claim 1, wherein the at least one nonwoven layer comprises at least 20 wt. % thermally stable nylon fibers.

5. The flame resistant thermal liner of claim 4, wherein the at least one nonwoven layer further comprises flame resistant fibers.

6. The flame resistant thermal liner of claim 5, wherein the at least one nonwoven layer comprises 30-80 wt. % flame resistant fibers.

7. The flame resistant thermal liner of claim 6, wherein the flame resistant fibers comprise at least one of aramid fibers, modacrylic fibers, or flame resistant cellulosic fibers.

8. The flame resistant thermal liner of claim 5, wherein the flame resistant fibers comprise para-aramid fibers and the at least one nonwoven layer comprises at least 20 wt. % para-aramid fibers.

9. The flame resistant thermal liner of claim 5, wherein the at least one nonwoven layer is devoid of meta-aramid fibers.

10. The flame resistant thermal liner of claim 1, wherein the at least one nonwoven layer comprises a spunlace fabric.

11. The flame resistant thermal liner of claim 1, wherein the at least one nonwoven layer comprises 40-70 wt. % thermally stable nylon fibers and 30-60 wt. % flame resistant fibers.

12. The flame resistant thermal liner of claim 11, wherein the flame resistant fibers comprise para-aramid fibers.

13. The flame resistant thermal liner of claim 11, wherein the at least one nonwoven layer comprises 50-70 wt. % thermally stable nylon fibers and 30-50 wt. % flame resistant fibers.

14. A garment composite comprising:
a. an outer shell layer comprising a flame resistant fabric;
b. a moisture barrier layer; and
c. a thermal liner layer comprising a flame resistant facecloth and at least one nonwoven layer attached to the facecloth, wherein the at least one nonwoven layer comprise thermally stable nylon fibers,
wherein the flame resistant facecloth is exposed on a first side of the garment composite and the outer shell layer is exposed on a second side of the garment composite opposite the first side.

15. The garment composite of claim 14, wherein the garment composite has a thermal protective performance rating of at least 35 calories/cm² when tested pursuant to ISO 17492.

16. The garment composite of claim 15, wherein the thermal protective performance rating is at least 40 calories/cm² when tested pursuant to ISO 17492.

17. The garment composite of claim 14, wherein the garment composite has a composite weight and a thermal protective performance rating when tested pursuant to ISO 17492, wherein a ratio of the thermal protective performance rating to composite weight is between 2.0 and 3.0, inclusive.

18. The garment composite of claim 14, wherein the at least one nonwoven layer further comprises flame resistant fibers and wherein the garment composite has a composite weight and a thermal protective performance rating when tested pursuant to ISO 17492, wherein a thermal protective performance rating to composite weight ratio of the garment composite is greater than a thermal protective performance rating to composite weight ratio of a comparative garment composite having at least one nonwoven layer formed of 100% flame resistant fibers but otherwise compositionally identical to the garment composite.

19. The garment composite of claim 18, wherein the thermal protective performance rating to composite weight ratio of the garment composite is at least 5% greater than the thermal protective performance rating to composite weight ratio of the comparative garment composite.

20. A nonwoven fabric formed of a fiber blend comprising flame resistant fibers and thermally stable nylon fibers.
